(19) United States
(12) Patent Application Publication
(10) Pub. No.: US 2001/0035408 A1
(43) Pub. Date: Nov. 1, 2001

(54) Country meat rack

(76) Inventor: Bette Adams, Mesa, AZ (US)

Correspondence Address: BETTE ADAMS, 300 S. VAL VISTA DR. #147, MESA, AZ, 85204, US

(21) Appl. No.: 09/804,859

(22) Filed: Mar. 13, 2001

Related U.S. Application Data
(60) Provisional application No. 60/188,748, filed on Mar. 13, 2000.

(51) Int. Cl. H05B 6/80

(52) U.S. Cl. 219/734; 219/733

(57) ABSTRACT

THIS MEAT RACK WILL BE OF MICROWAVE SAFE CONSTRUCTION, A BEVELED DRAIN PAN WITH INCORPORATED HANDLES AND A POURING LIP, REMOVABLE GRILL, DETACHABLE RACK TRAYS AND SUPPORT POSTS, AND A CLEAR COVER WITH TWO (2) VENT HOLES THAT CAN ALSO BE USED TO REMOVE THE COVER. THE ENTIRE UNIT CAN BE DISMANTLED FOR EASY CLEANING.

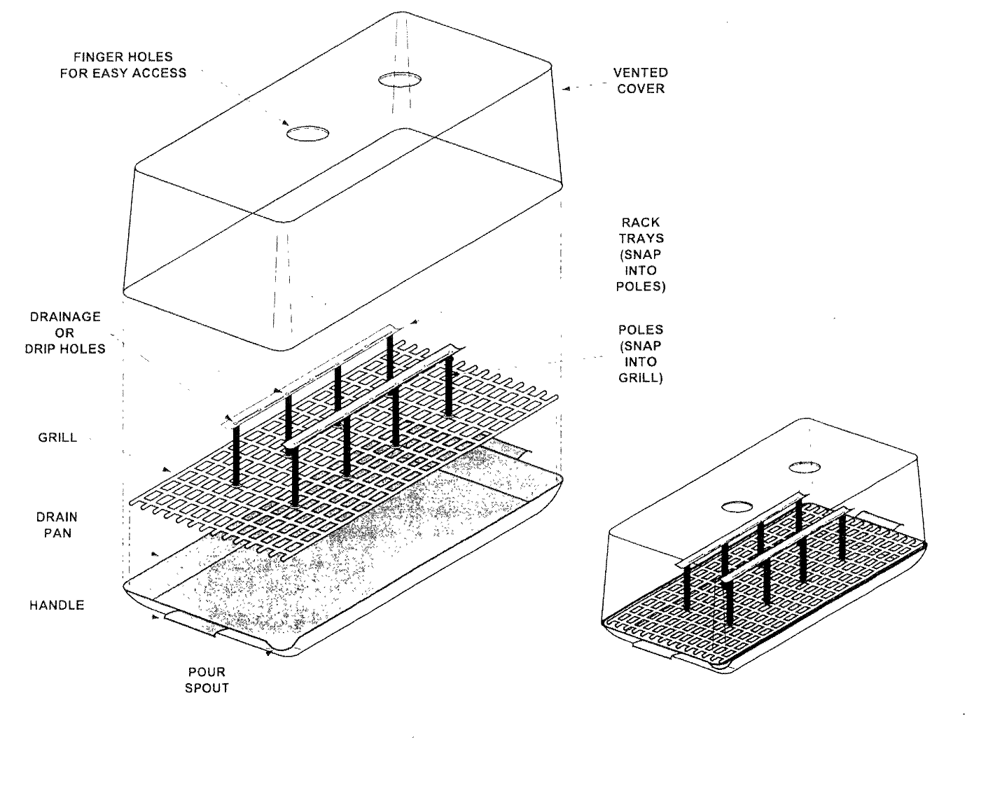

### SPECIFIC, UNIQUE FUNCTION OR PROPERTY OF INVENTION

“The Country Meat Rack” would be a cooking rack designed for use with bacon, sausage, pork, etc. The rack would have a beveled drain pan with incorporated handles, a cooking grill and raised rack trays that would snap to the cooking grill. The unit's clear cover would have top holes that would serve to both vent the rack and allow the user to lift the lid (by placing his/her fingers in the holes). Items would be placed either on the grill or draped over the rack trays, allowing drippings to collect in the drain pan.

### INVENTION FEATURES

“The Country Meat Rack” would feature a microwave-safe construction, a beveled drain pan with incorporated handles and a pouring lip, a removable grill, detachable rack trays and support posts, and a clear cover with vent/lift holes. The entire unit could be disassembled for cleaning.

### INVENTION BENEFITS

Use of “The Country Meat Rack” would allow the user to cook food items (bacon, sausage, pork, etc.) in a microwave oven without splattering grease inside the oven, while also helping to cook food in an more thorough and efficient manner.

### INVENTION VARIATIONS

As an option, “The Country Meat Rack” could be manufactured to include a fixed rack/drain pan assembly, or in a miniature version for sale as a toy or novelty item.

### INVENTOR'S SUGGESTED MATERIAL AND COMPONENTS

“The Country Meat Rack” would be fabricated from microwave-safe materials such as glass, ceramic and/or plastic.

### INVENTOR COMMENTS CONCERNING THE INVENTION

I came up with the idea for “The Country Meat Rack” because I got tired of cleaning the interior of my microwave from products on the market today. I am excited about this rack, because it not only completely dismantles for easy cleaning, but it also collects unwanted saturated fats down to the drain pan.

### MECHANICAL DESCRIPTION

“The Country Meat Rack” would be microwave-safe cookware consisting of a beveled drain pan with incorporated handles and a pouring lip, a removable grill and a clear cover with top holes that would both vent the device and serve as a lift handle (by placing the fingers inside the holes). Raised rack trays would snap or otherwise secure to the grill, mounted atop a number of vertical support posts. “The Country Meat Rack” could be fabricated from any number of microwave-safe materials, such as glass, ceramic and plastic, or a mixture of these components. As an option, “The Country Meat Rack” could be manufactured to include a fixed rack/drain pan assembly, or in a miniature version for sale as a toy or novelty item.

### USAGE

In use, the user would simply secure the upper rack trays to the grill of “The Country Meat Rack” thus allowing bacon to be draped over the rack trays. Other items such as sausage links, hot dogs, etc., could be placed upon the rack trays or in combination with bacon, as desired by the user. Meats such as chicken, patties, or ribs could be placed directly on the bottom grill. With its clear lid in place, “The Country Meat Rack” would be splatter-proof cookware that would allow the user to quickly and conveniently prepare food items in a microwave oven with a minimal amount of cleanup required. After cooking, collected grease could be poured from the drain pan by lifting the pan with its incorporated handles, and the entire unit could be disassembled for easy cleaning.

I claim that my invention of the Country Meat Rack to be a unique and an innovative idea:

1. It is specifically designed for convenience and efficiency for microwave use.

2. The Country Meat Rack has multiple uses.

3. A microwavable safe unit.

4. Is completely dismantable for easy cleaning.
